(19) United States
(12) Patent Application Publication
(10) Pub. No.: US 2024/0169722 A1
(43) Pub. Date: May 23, 2024

(54) LAND SEGMENTATION AND CLASSIFICATION

(71) Applicant: CarbonCo Limited, Nelson (NZ)

(72) Inventors: Crispin David LOVELL-SMITH, Nelson (NZ); Julian Roscoe MACLAREN, Nelson (NZ); Nicholas David BUTCHER, Nelson (NZ)

(21) Appl. No.: 18/550,927

(22) PCT Filed: Mar. 15, 2022
(86) PCT No.: PCT/NZ2022/050029

§ 371 Date: Sep. 15, 2023

(30) Foreign Application Priority Data
Mar. 15, 2021 (NZ) 773998

(51) Int. Cl. G06V 20/10; G06Q 30/018; G06V 10/26; G06V 10/764; G06V 10/774; G06V 10/82

(52) U.S. Cl. CPC G06V 20/188; G06Q 30/018; G06V 10/26; G06V 10/764; G06V 10/774; G06V 10/82

(57) ABSTRACT

A method for segmenting and classifying a unit of land, comprising: receiving land information comprising image data; processing received land information using a segmentation model trained on training data comprising training image data; and determining segmentation and classification for the unit of land; wherein the training image data comprises image data from different time points; and wherein the training image data comprises at least some of the image data.

### FIELD

This relates to land segmentation and classification.

### BACKGROUND

Land can be classified based on its characteristics. For example, the land can be urbanized land characterized by a large proportion of built infrastructure. Land can also be pasture characterized by a large proportion of farmland enclosed by fencing. Land can further be forest characterized by a dense distribution of trees. More refined classification may be possible based on more detailed characteristics.

### SUMMARY

In a first example embodiment, there is provided a method for segmenting and classifying a unit of land, comprising: receiving land information comprising image data; processing received land information using a segmentation model trained on training data comprising training image data; and determining segmentation and classification for the unit of land; wherein the training image data comprises image data from different time points; and wherein the training image data comprises at least some of the image data.

### BRIEF DESCRIPTION

The description is framed by way of example with reference to drawings which show certain embodiments. However, the drawings are provided for illustration only, and does not exhaustively set out all embodiments.

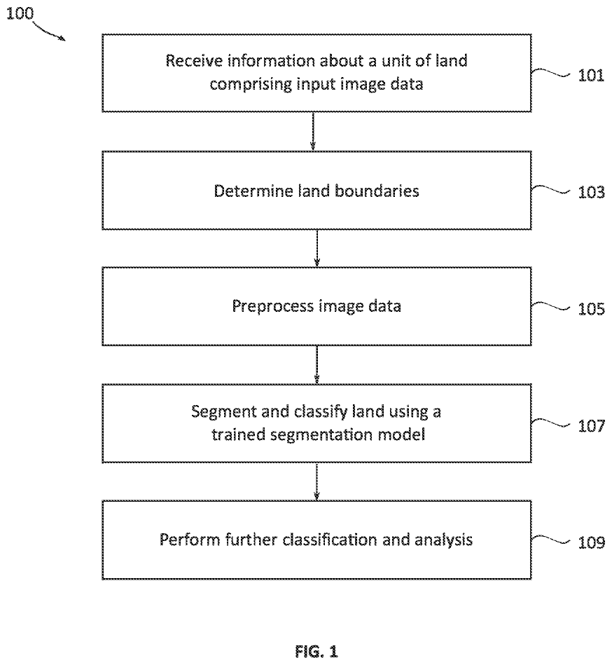

FIG. 1 shows an example method for segmenting and classifying a unit of land.

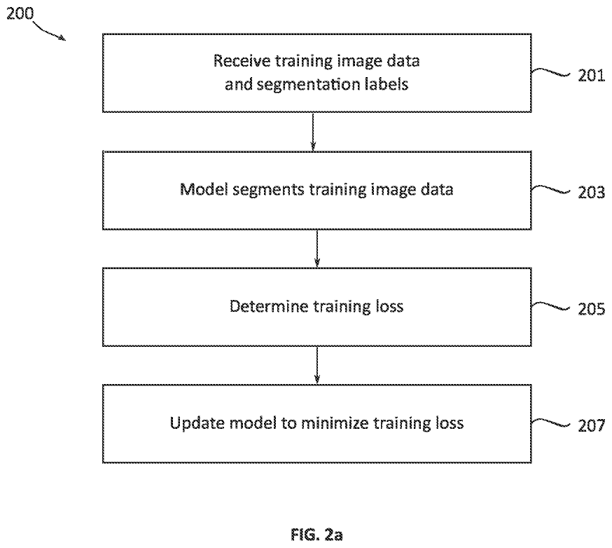

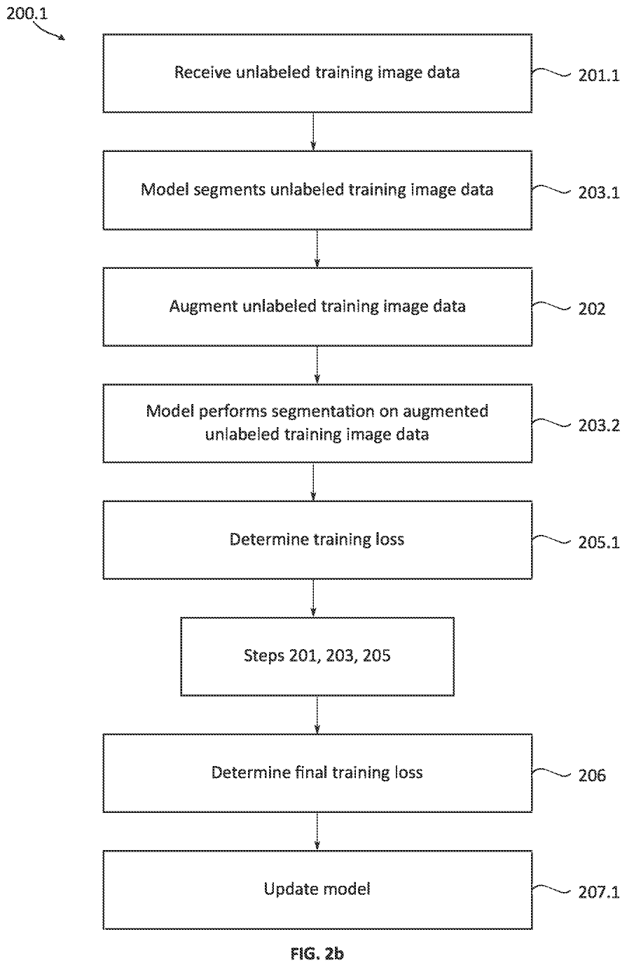

FIG. 2a shows a first example method for training a segmentation model.

FIG. 2b shows a second example method for training a segmentation model.

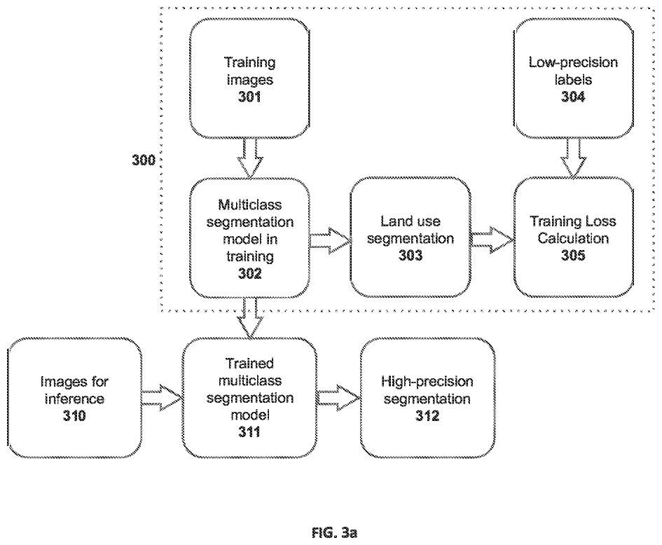

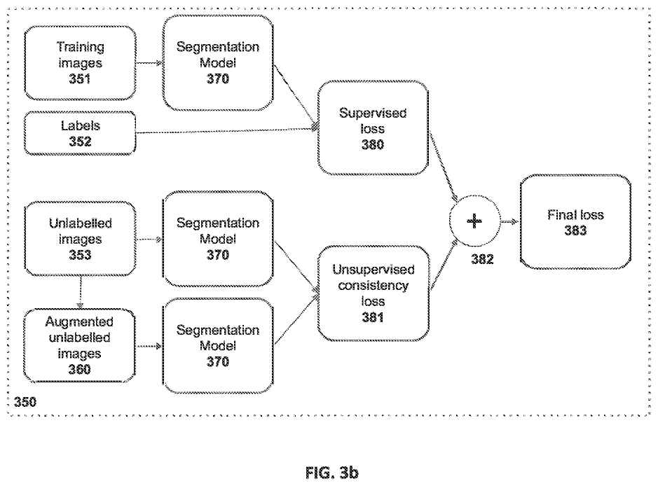

FIG. 3a shows an example information architecture corresponding to the approaches of FIG. 2a.

FIG. 3b shows an example information architecture corresponding to the approach of FIG. 2b.

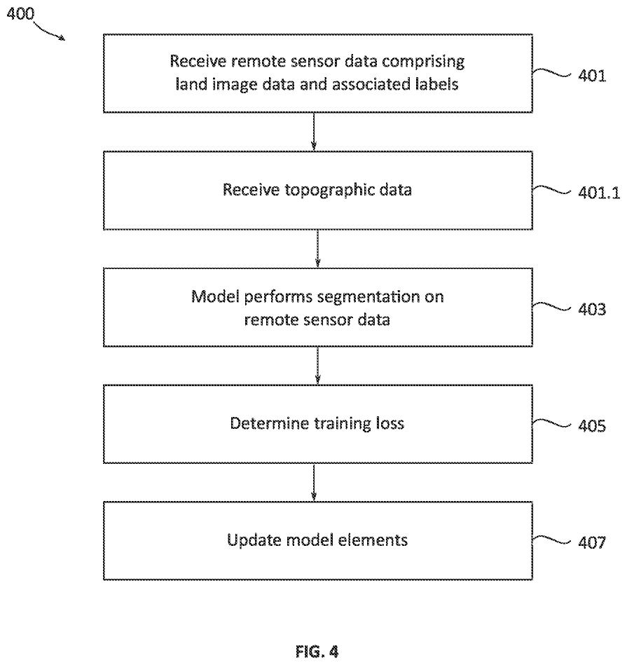

FIG. 4 shows a third example method for training a segmentation model.

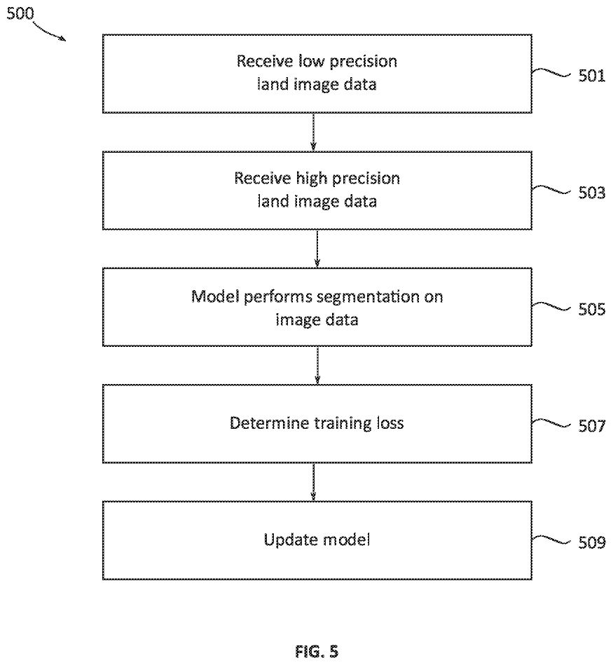

FIG. 5 shows a fourth example method for training a segmentation model.

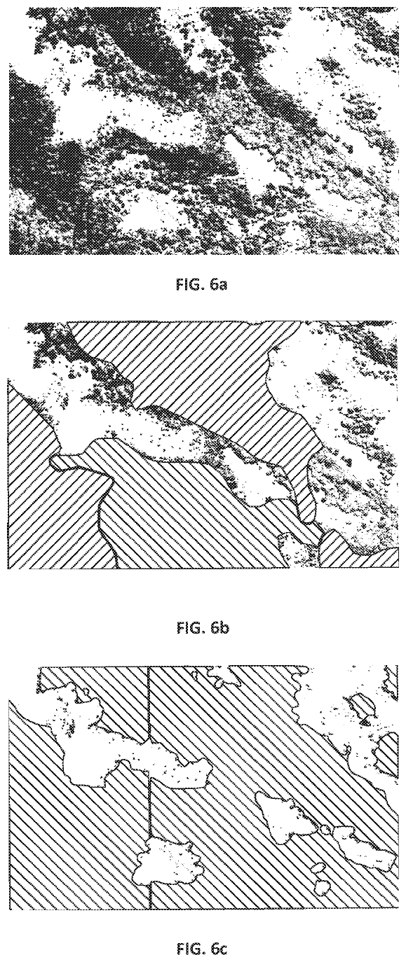

FIG. 6a shows an unlabeled image of an area of land.

FIG. 6b shows the image of FIG. 6a overlaid with a low precision label data.

FIG. 6c shows the image of FIG. 6a overlaid with a high precision segmentation from a model trained on the low precision label data.

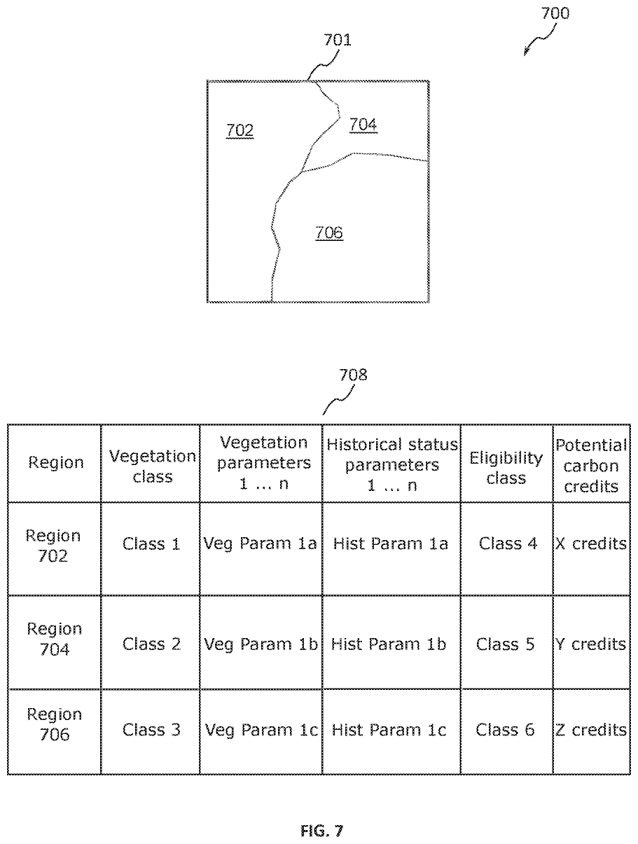

FIG. 7 shows an example of land segmentation.

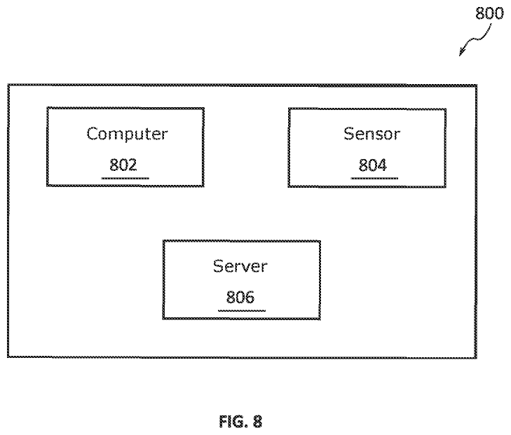

FIG. 8 shows an example system for segmenting and classifying a unit of land.

### DETAILED DESCRIPTION

A method is described which segments and classifies a unit of land based on certain characteristics of the unit of land, including characteristics obtainable upon analysis and processing of an image of the unit of land. In some cases, the land has vegetation, for example forestry. The method may then be applied to calculate characteristics of the vegetation, such as the type, age, and growth of the vegetation. This in turn may be used in calculating the carbon sequestration for an area.

### Segmentation and Classification

FIG. 1 shows an example method 100 for segmenting and classifying a unit of land using an image segmentation model.

At step 101, a program receives information about a unit of land comprising at least image data of the unit of land (the “input image data”).

Optionally at step 103, one or more boundaries are determined based on the information received at step 101. These boundaries may be used to divide the unit of land into multiple subunits. The subunits defined by the boundaries may be considered independent of one another.

In one example embodiment, the input image data is already in the form of rectangular image tiles. Otherwise, the input image data is divided into rectangular image tiles. Preferably, the rectangular image tiles are overlapping so as to avoid gaps.

Step 103 may be aided by a database lookup. The database may comprise a list of georeferenced polygons relating to the unit of land, in which case the boundaries may be substantially similar to the edges that define the georeferenced polygons.

Optionally at step 105, the image of the unit of land or a subunit is preprocessed. The preprocessing is described in more detail below.

At step 107, the unit of land or a subunit is segmented and classified using a trained segmentation model. The training of the segmentation model and the model itself are described in more detail below. The output of step 107 may be a list of segments of the unit of land or a subunit, where each segment is given a classification. More detailed examples of the output are described below. The classifications need not be unique: two different segments may have the same classification.

Optionally at step 109, the segmentation results from step 107 may undergo further classification and analysis. This may be achieved by comparing certain land characteristics with a set of predetermined rules and criteria. More detailed examples are described below.

### Segmentation Model

The segmentation model of method 100 may be an Al-based image segmentation model obtained using machine learning. In one example embodiment, the image segmentation model is a convolutional neural network (CNN). The development of such a model may involve training the model on training image data. Once trained, an image segmentation model may be used to perform step 107 of method 100 by making an inference based on at least the received image data.

FIG. 2a illustrates an example method 200 for training an image segmentation model. Method 200 uses supervised learning.

At step 201, a program receives training image data and associated segmentation labels. The training image data may be low-precision. That is, it is expected that the segmentation in these low-precision images will have relatively large errors when compared to an objective segmentation standard, obtainable through an ideal segmentation model. Conversely, high-precision segmentation refers to segmentation that has relatively small errors when compared to the same objective segmentation standard. In particular, the errors may be most prevalent in parts of the image that are closest to any boundaries between different image segments.

At step 203, a model in training performs segmentation on the received training image data. Preferably, the model is a multiclass image segmentation model based on a convolutional neural network, with an encoder-decoder structure such as a U-NET or the DeepLabV3+. The model may be untrained or partly trained.

At step 205, training loss is determined by comparing the segmentation obtained from step 203 with the labels associated with the training image data.

At step 207, the weights of at least a part of the model are adjusted according to a suitable objective function and a suitable optimization algorithm. The objective is to minimize the training loss obtained from step 205. One iteration of method 200 is complete after step 207. The training iterates until one or more predetermined criteria are met, and the latest model may be used in method 100.

### Semi-Supervised Learning

Method 200 may be adapted into a semi-supervised learning method 200.1 by incorporating unlabeled training image data, as shown in FIG. 2b. This may be the preferred training method if there is good availability and accessibility of unlabeled training image data.

At step 201.1, a program receives unlabeled training image data.

At step 203.1, a model in training performs segmentation on the received unlabeled training image data. Preferably, the model is a multiclass image segmentation model based on a convolutional neural network, with an encoder-decoder structure such as a U-NET or the DeepLabV3+. The model may be untrained or partly trained.

At step 202, the received unlabeled training image data undergoes augmentation. Augmentation refers to any processing of image data that does not alter the ground truths of the image data. Example augmentations include comprise image transformations such as rotations, translations, scaling, shearing, and any other transformation that transforms the image without changing the resultant objective segmentation standard. Preferably, the unlabeled training image data undergoes a diverse range of augmentations.

At step 203.2, a model in training performs segmentation on the augmented unlabeled training image data. Preferably, the model is a multiclass image segmentation3.2m3del based on a convolutional neural network, with an encoder-decoder structure such as a U-NET or the DeepLabV3+. The model may be untrained or partly trained.

Steps 202 and 203.2 may be performed before, in parallel with, or after step 203.1.

At step 205.1, a training loss different than the training loss of step 205 is determined. The training loss of step 205.1 is indicative of any inconsistencies between the segmentation obtained from step 203.1 and the segmentation obtained from step 203.2. If the model were ideal, then this training loss of step 205.1 would be zero since augmentation does not alter the ground truths.

Before step 206, steps 201, 203, and 205 need to have been performed and the training loss of step 205 obtained. But steps 201, 203, and 205 may be performed in any order with respect to steps 201.1, 203.1, 202, 203.2, and 205.1. The model of step 203 is the same model as that of step 203.1.

At step 206, a final training loss is obtained as a function of the training loss of step 205 and the training loss of step 205.1. Either of the two contributory losses may be preferentially weighted relative to the other.

At step 207.1, the weights of at least a part of the model are adjusted according to a suitable objective function and a suitable optimization algorithm. The objective is to minimize the final training loss obtained from step 206. One iteration of method 200.1 is complete after step 207.1. The training iterates until one or more predetermined criteria are met, and the latest model may be used in method 100.

FIG. 3a shows an example information architecture which demonstrates the information flows of FIGS. 2a.

Within a training loop 300, training image data 301 and low-precision labels 304 are used to train a multiclass segmentation model 302. During training, the model 302 produces segmentations 303. The produced segmentations 303 are used with low-precision labels 304 to calculate a training loss 305. The training loss 305 is used to determine when the model is trained. In particular, the training loop 300 may iterate training the model 202 on further training image data 301 until the training loss 305 is at, or sufficiently close to, zero.

The training image data 301 is sufficiently large that the model does not learn to replicate the errors in the labels. Such errors tend to be random and inherently unpredictable. Instead, the model 302 learns features that help determine the true classes in the input images. Although in many instances these true classes will not match the low-precision label exactly, and the loss function with therefore not evaluate to zero, on average over the very large dataset, these true classes provide the best estimate that generates the lowest loss on average.

Once the training loss 305 is sufficiently low, the model in training 302 becomes a trained multiclass segmentation model 311 ready for use. From here, non-training image data can be input to the trained multiclass segmentation model 311. This outputs a high-precision segmentation 312, which occurs despite the low-precision labels 304 having been used to train the model.

This approach provides a high precision (and therefore high accuracy) model for land segmentation with low precision (and therefore easily available or low cost) training data. This has shown to be particularly useful in calculating vegetation on land, and in particular when applied to calculating carbon sequestration of the vegetation.

FIG. 3b shows an example information architecture which demonstrates the information flows in using a training loop 350 to incorporate unlabeled data into model training as part of a semi-supervised learning approach. This may model the method shown in FIG. 2b.

This semi-supervised approach combines supervised loss 380 with unsupervised consistency loss 361 using a summation operation 382 to generate the final loss 383. The summation operation 382 may include a weighting function, such that either the supervised loss or the unsupervised consistency loss is weighted preferentially.

The supervised loss 380 is generated using a conventional approach: the training images 351 are input to a segmentation model 370 and the loss is calculated by comparing the model output to the labels 352, which are the assumed ground truth.

The unsupervised consistency loss 361 is generated by comparing the difference between two model outputs: that generated by inputting unlabeled images 353 into the segmentation model 370 and that generated by inputting augmented versions 360 of the same unlabeled images 353 into the segmentation model 370.

If the model is well trained, then in an ideal situation this unsupervised consistency loss 381 would be equal to zero. This is because the augmentations applied in 360 do not alter the ground truth (which is unknown), so the model would ideally generate the same result regardless of the augmentation. Example augmentations include affine image transformations such as rotations, translations, scaling and shearing, and any other transformation that perturbs the image without changing the expected output class labels.

### Preprocessing

Referring to step 105 of method 100, preprocessing may be implemented before inference at step 107 to mitigate factors which can obscure the ground truths of the image of the unit of land. These factors may include, without limitation, terrain-dependent variations, solar-illumination-dependent variations, and sensor-viewing-angle-dependent variations, in land cover spectral signature.

Topographical correction or normalization may improve subsequent processing of an image through elimination of the effect of shadows and relief, especially in steep slope areas.

The preprocessing of step 105 may use one or more of the Cosine method, the Minnaert method, the C correction method, and the Statistical-Empirical method.

The preprocessing at step 105 may also comprise up-sampling the input image data. Up-sampling refers to increasing the resolution of image data. Up-sampling may be crucial in applications where the input image data is only available as low-resolution image data. This may be the case if the input image data is too low resolution for the content. At step 103, the input image data may be up-sampled using various transforms, such as Fourier interpolation or linear interpolation.

### Additional Training—Topographical Normalization

FIG. 4 illustrates how an image segmentation model may be iteratively trained to compensate for the aforementioned factors according to a method 400. Method 400 may be used as an alternative or in addition to the preprocessing of step 105.

At step 401, a program receives remote sensor data (e.g. satellite imagery) comprising image data of a unit of land with associated segmentation labels.

At step 401.1, the program receives topographic data of the unit of land. This can occur before, in parallel with, or after step 401.

At step 403, a model performs segmentation on the remote sensor data. This model may be a partially trained model or an untrained model. Preferably, the model is a multiclass image segmentation model based on a convolutional neural network, with an encoder-decoder structure such as a U-NET or the DeepLabV3+. Preferably, the model chosen is able to be effectively fitted to multiple input channels simultaneously and is able to learn multiple distinct kernel functions for different factors or characteristics. As an example, the encoder-decoder structure may encode the spectral signature for a particular segmentation class given the illumination source. An example encoded class may be “forest in shade”, contrasting “forest in sunlight”.

The model may be untrained or partly trained.

Further, the model may comprise multiple elements, each element corresponding to one of the aforementioned factors. Each element may have its own weights that can be updated from one iteration to the next.

At step 405, a training loss is determined by comparing the segmentation obtained from step 403 to the labels associated with the remote sensor data.

At step 407, the weights of at least some of the elements of the model are adjusted according to a suitable objective function and a suitable optimization algorithm. The objective is to minimize the training loss obtained from step 405. One iteration of method 400 is complete after step 407. The training iterates until one or more predetermined criteria are met, and the latest model may be used in method 400.

### Additional Training—Up-Sampling

FIG. 5 illustrates how an image segmentation model may be iteratively trained to achieve up-sampling and output high-precision segmentation as part of the inference step 107. Method 500 may be used as an alternative or in addition to the preprocessing of step 105.

At step 501, a program receives low-precision training image data relating to a unit of land.

At step 503, the program receives high-precision training image data relating to the same unit of land and associated high-precision segmentation labels. This may occur before, in parallel with, or after step 501.

At step 505, a model under training performs segmentation on the training image data. Preferably, the model is a multiclass image segmentation model based on a convolutional neural network, with an encoder-decoder structure such as a U-NET or the DeepLabV3+. The model may be untrained or partly trained.

At step 507, a training loss is determined by comparing the segmentation obtained from step 505 to the high-precision segmentation labels associated with the high-precision training image data.

At step 509, the weights of at least a part of the model are adjusted according to a suitable objective function and a suitable optimization algorithm. The objective is to minimize the training loss obtained from step 507. One iteration of method 500 is complete after step 509. The training iterates until one or more predetermined criteria are met, and the latest model may be used in method 100.

### Training Image Data

Any training image data of any one of methods 200, 200.1, 400, or 500 may comprise image data from different time points. This may be achieved by using imagery obtained from the joint NASA and US Geological Survey Landsat Missions, or from other suitable imagery sources. By using image data from multiple time points, it is possible for the model to learn not only current land information but also historic information. This may be critical in carbon credit applications (described in more detail below), where whether land use changes occur before or after a particular date can be important for determining carbon credit eligibility. Preferably, the training image data comprises image data that was acquired prior to 1 Jan. 1990.

The training image data of any one of methods 200, 200.1, 400, or 500 may be substantially similar to the input image data from which a trained image segmentation model will infer a result. In other words, any inference by a trained image segmentation model may be a higher-precision version of the low-precision segmentation of the training image data, as opposed to segmentation on unseen image data.

The training image data of any one of methods 200, 200.1, 400, or 500 is trained using an existing database covering the same region that the model will be used to evaluate. may be a large dataset, especially if the training image data is low-precision. A large dataset may be on the order of thousands or millions of data points. One such system is New Zealand's Land Use and Carbon Analysis System (LUCAS). This provides a large, though relatively low precision, set of labelled data.

Conventionally, low precision training data impeded the precision of models built using that data. However, in this case, the approaches noted above result in a high precision segmentation from low precision data.

For example, in the case that the errors in the training image data have a level of randomness, the training noted above tends to avoid the model learning these errors as the effects of the individual errors on the model will likely cancel out given a sufficiently large training data set. That is, the trained model will likely be based on ground truths and not be influenced by the lack of precision in the training image data.

This can therefore allow the use of a low precision input without jeopardizing the precision of the output.

The training image data may be obtained using aerial photography. Preferably, the training image data is obtained from a satellite. The training image data may vary in spectral content and/or spatial resolutions.

In some cases, the training image data are rectangular image tiles. However, only the central part of the tile may contribute to determining training loss. This may require overlapping tiles to avoid gaps between proximate tiles. This may have the benefit of reduced edge effects and hence improved precision of the trained model.

In one example embodiment, the training image data relates to land of a territory that is different from the territory to which the unit of land belongs in method 100.

### Example Application

FIGS. 6a, 6b, and 6c show example images of how the described approaches can allow high precision segmentation to occur using low-precision training data (in particular, low-precision labels for image data).

FIG. 6a shows an unlabeled image of an area of land. The land has vegetation cover across certain parts. This image may have been obtained from aerial photograph or the like. In this case, the image is relatively high-precision, due to the resolution showing a high level of detail.

FIG. 6b shows low-precision segmentation overlaid on the image of FIG. 6a. The data in this case is from New Zealand's Land Use and Carbon Analysis System (LUCAS), which provides relatively low precision label data. In this case, the low-precision data identifies portions of the area with vegetation. However, due to the low-precision nature, the overlay includes non-vegetation portions and excludes vegetation portions. This limits the use of the data, for example for calculating carbon sequestration.

FIG. 6c shows high-precision segmentation derived from use of the approaches noted above. This is shown overlaid on the image of FIG. 6a. The overlay closely matches the actual vegetation portions of the land, and therefore is significantly higher precision than that in FIG. 6b. This is calculated using the image data with the low-precision label data from LUCAS as training data. This provides a robust approach for high precision segmentation based on low-precision training data.

### Applications

In some cases, the segmentation approaches described above may be adapted for use in calculating characteristics of the land, and in particular the vegetation on the land. One such approach may calculate levels of carbon sequestered in the growth of the vegetation on the land. This may in turn assist in deriving carbon credit eligibility information.

FIG. 7 shows an example embodiment of the invention relating to carbon credits. Given information of a unit of land including image data of the unit of land, method 100 may be used to derive carbon credit eligibility information and present the information to a landowner.

A map 701 of the unit of land is segmented into regions 702, 704 and 706 using method 100. Classification information about the regions may be presented in a table 708, which may show which vegetation class each region belongs to and the potential carbon credits the regions may be eligible for. The eligibility analysis may occur at step 107, comparing the results from 105 against a set of predetermined carbon credits regulations.

Table 708 may contain additional vegetation parameters. Preferably, these additional vegetation parameters comprise canopy cover fraction, canopy height, dominant species, species mix, average overall age, average age for a particular species, distribution of ages by species, as well as key vegetation coverage indicators such as the normalized difference vegetation index (NDVI) and their relevant historical status parameters. Preferably, the historical status parameters comprise years of deforestation since 1990, deforested periods since 1990, and years of land use management changes since 1990.

In one example embodiment, a web interface is provided, whereby a landowner can select a unit of land and determine carbon credit eligibility. Method 100 may be executed in substantially real-time, such that the results can be presented to the landowner also in substantially real-time. The substantially real-time responsiveness may be achieved by performing some or all of the steps of method 100 on a computer with a graphics processing unit (GPU), a tensor processing unit (TPU), or another suitable array processor.

The output visible at the web interface may comprise a decomposition of a unit of land into different classifications, where each classification describes information about current and past land use, carbon credit eligibility information, and possibly recommendations. An example is now described. Using method 100, a 10-hectare unit of land is segmented into four regions: the first and second regions are each 2 hectares of indigenous forest, the third region is 3 hectares of high productivity land, and the fourth region is 3 hectares of relatively unproductive land which could potentially be used to earn credits on a carbon market. In particular, the first region is found to be eligible while the second region ineligible, by analyzing historical records where necessary and comparing to the relevant carbon credits regulations. A possible recommendation may be to repurpose the fourth region in order to earn carbon credits. In some cases, the recommended approach is the cheapest and simplest approach e.g. using fencing to exclude stock and allow rewilding. The recommendation may further comprise a value breakdown, whereby the value of carbon credits is presented for a variety of possible land use changes.

In certain example embodiments, multiple units of land may be processed so as to cover a large landmass, which may be an entire country. Such a project could be considered a proactive and comprehensive evaluation of carbon market eligibility. In this way, the vast majority if not all possible carbon reduction projects may be identified and assessed. Processing of multiple units of land may occur sequentially or in parallel.

In certain example embodiments, the output of method 100 may be sent directly to the carbon market regulator of a given jurisdiction as a report. This may occur as part of an automated carbon project registration or carbon credit application process. Generation of the report, including any requisite formatting or structuring, may occur as part of method 100 or as an additional process. This approach may help improve the efficiency of the carbon credits system if the regulator would benefit from the increased quality and consistency of this standardized and automated reporting. That is, the report received by the regulator would very likely already be in the correct format and have the requisite supporting evidence, potentially making it easier to assess compliance with carbon market regulations.

In certain example embodiments, method 100 is repeated over a period of time for ongoing monitoring of a unit of land. This may allow regulatory bodies to ensure that landowners are meeting their obligations in relation to carbon credits. It can also monitor and prevent activities such as illegal deforestation.

### System

FIG. 8 shows an example system which may be used to implement the methods described above.

System 800 comprises a computer 802 comprising a processing unit, a memory, and one or more peripherals. The processing unit may be one or more of a CPU, a GPU, a TPU, or another array processor. Computer 802 is not necessarily a single device. The tasks handled by computer 802 may comprise training an image segmentation model, performing segmentation using a trained segmentation model, handling data access to and from databases, performing analysis based on segmentation results, and communicating the results to another device, possibly via server 806.

System 800 also comprises a sensor 804. The sensor 804 is configured to acquire data relating to a unit of land including at least image data. The acquired data may be used for training an image segmentation model or used as input for a trained image segmentation model. Sensor 804 may comprise a camera, an imaging satellite, or another device or system for aerial photography.

Server 806 may enable any communication between computer 802 and another node in a network. As an example, server 806 may direct any segmentation results obtained at computer 802 to a regulator of carbon credits.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A method for segmenting and classifying a unit of land, comprising:
receiving land information comprising image data;
processing received land information using a segmentation model trained on training data comprising training image data; and
determining segmentation and classification for the unit of land;
wherein the training image data comprises image data from different time points;
and
wherein the training image data comprises at least some of the image data.

2. The method of claim 1, wherein the unit of land comprises vegetation, and the image data comprises image data of the vegetation.

3. The method of claim 2, further comprising calculating a carbon value for the unit of land based on the vegetation.

4. The method of claim 1, further comprising determining carbon credit eligibility information.

5. The method of claim 4, further comprising sending the determined segmentation, classification, and carbon credit eligibility information to a carbon market regulator.

6. The method of claim 1, wherein the method is repeated over a period of time for ongoing monitoring of the unit of land.

7. The method of claim 1, wherein the segmentation model is a multiclass segmentation model.

8. The method of claim 1, wherein the segmentation model is trained in a semi-supervised manner.

9. The method of claim 1, wherein at least some of the training image data is augmented.

10. The method of claim 1, wherein at least some of the training image data is low-precision.

11. The method of claim 1, wherein the training data comprises label information.

12. (canceled)

13. The method of claim 1, further comprising compensating for topographic factors with the segmentation model.

14. (canceled)

15. The method of claim 1, further comprising up-sampling the image data with the segmentation model.

16. (canceled)

17. The method of claim 1, wherein the segmentation model is a convolutional neural network with an encoder-decoder structure.

18. The method of claim 17, wherein the convolutional neural network with an encoder-decoder structure is a U-net.

19. (canceled)

20. The method of claim 1, wherein at least some of the training image data is obtained using aerial photography and/or is obtained from a satellite.

21. (canceled)

22. The method of claim 1, wherein the training image data varies in spectral content.

23. The method of claim 1, wherein the training image data has a wide range of spatial resolutions.

24. (canceled)

25. (canceled)

26. A system configured to perform the method of claim 1.

27. A non-transitory computer readable medium comprising instructions which, when executed by one or more processors, cause the one or more processors to perform the method of claim 1.

28. (canceled)
